(19) United States
(12) Patent Application Publication
(10) Pub. No.: US 2025/0312649 A1
(43) Pub. Date: Oct. 9, 2025

(54) SYSTEMS AND METHODS FOR AGENTIC OPERATIONS USING MULTIMODAL GENERATIVE MODELS FOR TENNIS

(71) Applicant: STATS LLC, Chicago, IL (US)

(72) Inventors: Patrick Joseph LUCEY, Chicago, IL (US); Christian MARKO, Graz (AT); Robert SEIDL, Munich (DE)

(73) Assignee: Stats LLC, Chicago, IL (US)

(21) Appl. No.: 19/169,427

(22) Filed: Apr. 3, 2025

Related U.S. Application Data
(60) Provisional application No. 63/574,701, filed on Apr. 4, 2024.
(60) Provisional application No. 63/774,286, filed on Mar. 19, 2025.

(51) Int. Cl. A63B 24/00; G06F 40/40; G06N 3/042

(52) U.S. Cl. CPC A63B 24/0021; G06N 3/042; A63B 2024/0056; G06F 40/40

(57) ABSTRACT

Disclosed techniques relate to using one or more of tennis match statistics, textual insights, predictions (e.g., team and player at the match level, and team at the season level), graphics, video overlays, and player and ball tracking data. Tracking data may be generated using an in-venue feed or a broadcast feed. The tracking data may be supplemented with event data which may be provided by an operator or an automated system based on the events related to a given sport within a venue or via a broadcast feed. The tracking data and/or event data may be used to generate insights such as match statistics, textual insights, predictions, graphics, video overlays, and or the like. Accordingly, the tracking data and insights generated in accordance with the subject matter disclosed herein may be specific to a given sporting event and/or the sport associated with the sporting event.

### CROSS-REFERENCE TO RELATED APPLICATIONS

This application claims the benefit of priority to U.S. Provisional Application Nos. 63/574,701 and 63/774,286 filed on Apr. 4, 2024 and Mar. 19, 2025, respectively, each of which are incorporated by reference in their entireties.

### TECHNICAL FIELD

Various embodiments of the present disclosure relate generally to machine-learning-based techniques for generating sports event data and, more particularly, to systems and methods for extracting and processing user inputs as they relate to sports event data and performing targeted agentic operations based on the user inputs.

### INTRODUCTION

Generative artificial intelligence (AI) applications that exist today focus on the task of using text to generate an image, video, or audio (or a combination of video and audio). This is done by using generative AI techniques to learn the mapping from one modality to the other. A use of this technology is also found in a conversational aspect, where refinements on an initial description can occur to improve the output.

Unless otherwise indicated herein, the materials described in this section are not prior art to the claims in this application and are not admitted to be prior art, or suggestions of the prior art, by inclusion in this section.

### SUMMARY

In some aspects, the techniques described herein relate to a system for performing an action using agentic artificial intelligence (AI), the system including: a tennis specific orchestrator; a plurality of agents, wherein each agent is associated with the tennis specific orchestrator; a superior orchestrator trained to select one or more sport specific orchestrators including the tennis specific orchestrator, wherein the tennis specific orchestrator is trained to select a one or more agents to perform an action based on one or more user inputs, wherein the superior orchestrator is configured to execute instructions for: receiving the one or more user inputs, wherein the one or more user inputs include a description; determining contextual information and intentional information associated with the description; selecting the one or more sport specific orchestrators, including the tennis specific orchestrator, based on the contextual information and intentional information associated with the description, wherein each of the one or more sport specific orchestrators are trained using one or more sport specific languages, and wherein the tennis specific orchestrator is trained using a tennis specific language, wherein the one or more sport specific orchestrators, including the tennis specific orchestrator, are configured to execute instructions for: selecting the plurality of agents for performing the action associated with the description based on the contextual information and the intentional information, wherein the one or more agents are configured to execute instructions for: retrieving a plurality of information based on the contextual information and intentional information; determining steps for performing the action associated with the description; and activating agent processes to perform the action based on the determined steps for performing the action.

In some aspects, the techniques described herein relate to a system, wherein the one or more user inputs include at least one of text, audio, drawing, or video.

In some aspects, the techniques described herein relate to a system, wherein determining the plurality of contextual information and intentional information further includes: extracting one or more metadata items relating to the description; and determining at least one keyword or tag associated with the description.

In some aspects, the techniques described herein relate to a system, wherein selecting the plurality of agents further includes: mapping one or more metadata items to at least one or more event streams; and determining at least one keyword or tag associated with the one or more metadata items relating to the at least one or more event streams.

In some aspects, the techniques described herein relate to a system, wherein performing the action includes generating one or more sports content based on the information received and wherein the one or more agents are configured to execute instructions for: matching the at least one keyword or tag associated with the description to the determined at least one keyword or tag relating to the at least one or more event streams.

In some aspects, the techniques described herein relate to a system, wherein generating the one or more sports content further includes retrieving one or more content items relating to a subset of the at least one or more event streams.

In some aspects, the techniques described herein relate to a system, wherein each of the plurality of agents are trained to retrieve the plurality of information relating to one or more sports tracking data and one or more sports event data, and to arrange the one or more sports tracking data and the one or more sports event data for performing the action.

In some aspects, the techniques described herein relate to a method for performing a tennis related action, the method including: receiving one or more user inputs, wherein the one or more user inputs include at least a description; determining a plurality of contextual and intentional information associated with the description; determining a tennis specific language model based on the plurality of contextual and intentional information; determining one or more tennis events and tracking data based on the plurality of contextual and intentional information; and retrieving one or more content items relating to the one or more tennis events and tracking data using the tennis specific language model; and transmitting the one or more content items for display on a user device.

In some aspects, the techniques described herein relate to a method, wherein the tennis specific language is trained using one or more sport generic attributes and tennis specific attributes.

In some aspects, the techniques described herein relate to a method, wherein the sport generic attributes includes a number of players, a type of surface, a team sport, or an individual sport.

In some aspects, the techniques described herein relate to a method, wherein the tennis specific attributes includes a starting line-up, a possession based sport, a segmented sport, a time constraint, a point distribution, or a penalty based sport.

In some aspects, the techniques described herein relate to a method, wherein determining a plurality of contextual and intentional information further includes: extracting one or more metadata items relating to the description; determining at least one keyword or tag associated with the description; and mapping the one or more metadata items to the at least one keyword or tag.

In some aspects, the techniques described herein relate to a method, wherein determining the tennis specific language models further includes: matching the at least one keyword or tag with the sport generic attributes and the tennis specific attributes; determining a threshold number of tennis specific attributes identified for the tennis specific language model, wherein if the threshold number of tennis specific attributes for one of the tennis specific language model is exceeded, then selecting the tennis specific language.

In some aspects, the techniques described herein relate to a non-transitory computer readable medium configured to store processor-readable instructions, wherein when executed by a processor, the instructions perform operations including: a superior orchestrator trained to select one or more sport specific orchestrators including a tennis specific orchestrator, wherein the tennis specific orchestrator is trained to select a plurality of agents to perform an action based on one or more user inputs, wherein the superior orchestrator is configured to execute instructions for: receiving the one or more user inputs, wherein the one or more user inputs include a description; determining contextual information and intentional information associated with the description; selecting the one or more sport specific orchestrators, including the tennis specific orchestrator, based on the contextual information and intentional information associated with the description, wherein each of the one or more sport specific orchestrators are trained using one or more sport specific languages, and wherein the tennis specific orchestrator is trained using a tennis specific language, wherein the one or more sport specific orchestrators, including the tennis specific orchestrator, are configured to execute instructions for: selecting the plurality of agents for performing the action associated with the description based on the contextual information and the intentional information, wherein the one or more agents are configured to execute instructions for: retrieving a plurality of information based on the contextual information and intentional information; determining steps for performing the action associated with the description; and activating agent processes to perform the action based on the determined steps for performing the action.

In some aspects, the techniques described herein relate to a non-transitory computer readable medium, wherein the one or more user inputs include at least one of text, audio, drawing, or video.

In some aspects, the techniques described herein relate to a non-transitory computer readable medium, wherein determining the plurality of contextual information and intentional information further includes: extracting one or more metadata items relating to the description; and determining at least one keyword or tag associated with the description.

In some aspects, the techniques described herein relate to a non-transitory computer readable medium, wherein determining the plurality of agents further includes: mapping one or more metadata items to at least one or more event streams; and determining at least one keyword or tag associated with the one or more metadata items relating to the at least one or more event streams.

In some aspects, the techniques described herein relate to a non-transitory computer readable medium, wherein performing the action includes generating one or more tennis content based on the information received and wherein the one or more agents are configured to execute instructions for: matching the at least one keyword or tag associated with the description to the determined at least one keyword or tag relating to the at least one or more event streams.

In some aspects, the techniques described herein relate to a non-transitory computer readable medium, wherein generating the one or more tennis content further includes retrieving one or more content items relating to a subset of the at least one or more event streams.

In some aspects, the techniques described herein relate to a non-transitory computer readable medium, wherein each of the plurality of agents are trained to retrieve the plurality of information relating to one or more tennis tracking data and one or more tennis event data, and to arrange the one or more tennis tracking data and the one or more tennis event data for performing the action.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts block diagram illustrating a computing environment, according to example embodiments.

FIG. 2 depicts an exemplary flowchart for agentic artificial intelligence (AI) selection, according to example embodiments.

FIGS. 3A and 3B depict exemplary AI agents, according to example embodiments.

FIG. 4 depicts an exemplary flowchart of a method for performing an action using agentic artificial intelligence (AI), according to example embodiments.

FIG. 5 depicts a flowchart of a method for generating an interactive display for a sports content data stream, according to example embodiments.

FIG. 6 depicts an example flowchart for generating tracking and/or event data, according to example embodiments.

FIGS. 7-8 depicts flow diagrams of an exemplary method for using machine-learning models to generate sports tracking data, according to example embodiments.

FIG. 9 depicts an example use of generating sports tracking data within an AR/VR and Mixed reality application, according to example embodiments.

FIG. 10 depicts another example of generating sports tracking data, according to example embodiments.

FIG. 11A depicts an example assisted query input interface, according to one or more embodiments.

FIG. 11B depicts another example assisted query input interface, according to one or more embodiments.

FIG. 12 depicts an example output interface, according to one or more embodiments.

FIG. 13 depicts an example graphic output interface, according to one or more embodiments.

FIG. 14 depicts a flow diagram for training a machine-learning model, according to example embodiments.

FIG. 15A depicts a block diagram illustrating a computing device, according to example embodiments

FIG. 15B depicts a block diagram illustrating a computing device, according to example embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to machine-learning for sports applications, in particular various aspects relate to the systems and methods for using sports specific data (e.g., tracking data) identified based on user inputs to perform one or more agentic actions. Various embodiments may use machine learning models to automatically generate information or perform actions relating to sporting events and the use thereafter. An event can refer to a particular play such as a pass or a goal, but can also refer to an entire match. As discussed, existing solutions are unable to generate accurate information relating to sports events.

According to aspects disclosed herein, a multimodal sports learning language model (LLM) may receive text, audio, video, or drawings as inputted information from a user. The multimodal sports LLM may use preprocessed event streams to map corresponding metadata to the user input information. This information may be used in the multimodal sports LLM to determine generated sports tracking data that is output to the user or is used by one or more sports specific agents to perform one or more actions. The outputted information may be in the form of visualizations, retrieval systems, analyses, audio and/or textual commentary or a combination thereof. The outputted information may be event and/or tracking data that is generated by the multimodal sports LLM and/or historical event and/or tracking data that is associated with the user input query information. The performed actions may include, for example, generating a highlight reel, generating a narrative and/or story, predicting game outcomes, analyzing the effects of a referee during a game, simulating player movements throughout a game, comparing playing styles of one or more players, or the like.

The following non-limiting example is introduced for discussion purposes. In the example, a system receives user input for querying sporting event and accesses relevant database records from a database. The database records can include sports-related data associated with the sporting event such as player, team, and/or league related information. The system determines intentional and contextual information from the query. This information is then mapped to database records to generate or retrieve sports tracking data based on the received query. The system can output information based the generated sports tracking data or the sports tracking data to the client device. For example, a user query may relate to comparing the playing style of two or more players for an upcoming match. The system may output a series of text, video, audio, or the like to describe the playing style (e.g., aggressive, defensive, or the like) for each player. In addition, the system may further prepare a similar output highlighting the differences in paying styles between the two players.

Technical advantages of the disclosed techniques include improvements to machine learning. For instance, certain aspects relate to determining intentional and contextual information from a user input that improve the performance, accuracy, and results of information to be mapped to sports-related data. In doing so, disclosed techniques provide improvements relative to existing solutions.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

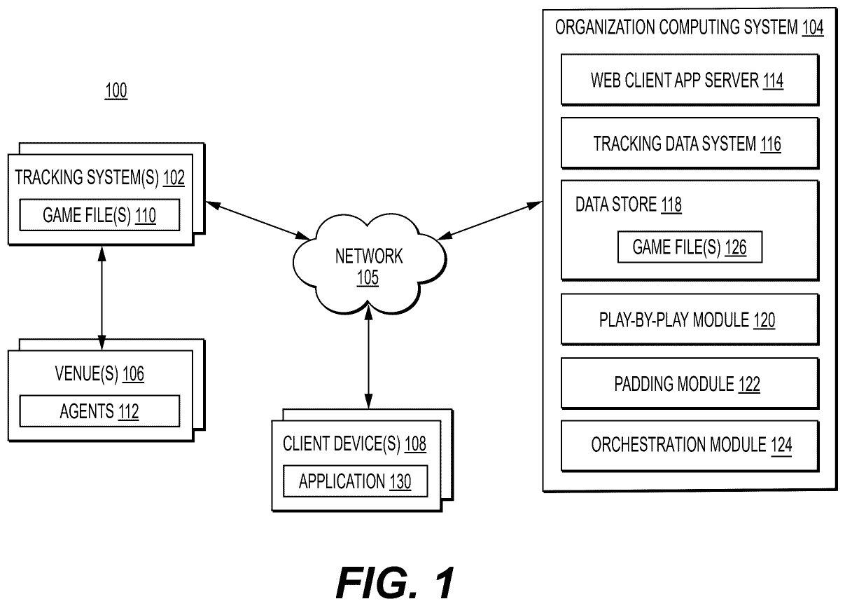

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream(s) and/or in-venue feed(s) of the game. Organization computing system 104 may include at least a web client application server 114, tracking data system 116, data store 118, play-by-play module 120, padding module 122, and/or orchestration module 124. Each of tracking data system 116, play-by-play module 120, padding module 122, and orchestration module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). Such tracking data may be a digitized representation of the actions or event performed during a match and may further include predictive or simulated data that, for example, automatically fills in gameplay gaps in a broadcast feed coverage. For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for orchestration module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the umpires, in some situations, are the ultimate decision makers in the successful outcome of an event. For example, in tennis, whether the ball position is in or out of bounds is determined by the umpires. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Orchestration module 124 may be configured or trained to generate connections and/or associations within prompts of a multimodal sports LLM and user inputs (e.g., audio, speech, drawings, video, etc.) to determine the appropriate individual orchestrators (e.g., sport specific orchestrators) and agents for performing one or more actions. The orchestration module 124 may include a superior orchestrator, a plurality of sport specific orchestrators, and a plurality of agents associated with one or more of the sport specific orchestrators. According to an embodiment, each agent may be associated with a single sport specific orchestrator such that each agent associated with a given sport specific orchestrator is trained based on training data associated with the corresponding sport. The orchestration module 124 may be configured to receive a user input (e.g., audio/speech) requesting information relating to a specific match (e.g., Manchester United vs. Liverpool) or sport (e.g., soccer, basketball, football, rugby, tennis, golf, individual sport, team sport, etc.). Orchestration module 124 may generate one or more connections and/or associations (e.g., contextual information and intentional information) based on the user input and the event stream (e.g., match between Manchester United against Liverpool). Based on the generated connections, orchestration module 124 may be configured to determine event data associated with the event stream and the user input.

The orchestration module 124 may be configured to select one or more sport specific orchestrators based on the one or more connections and/or associations. Each sport specific orchestrator may be trained using one or more sport specific languages. The one or more sport specific orchestrators may be configured to select a plurality of agents for performing one or more actions associated with the user input based on the connections and/or associations. The plurality of agents may be configured to retrieve a plurality of information based on the connections and/or associations and determine steps for performing the one or more actions associated with the user input. Upon receiving information from the plurality of agents, the orchestration module 124 may output (e.g., one or more graphics, text, audio, or a combination thereof) the results of the one or more actions performed by the plurality of agents based on the determined connections and/or associations with the user input.

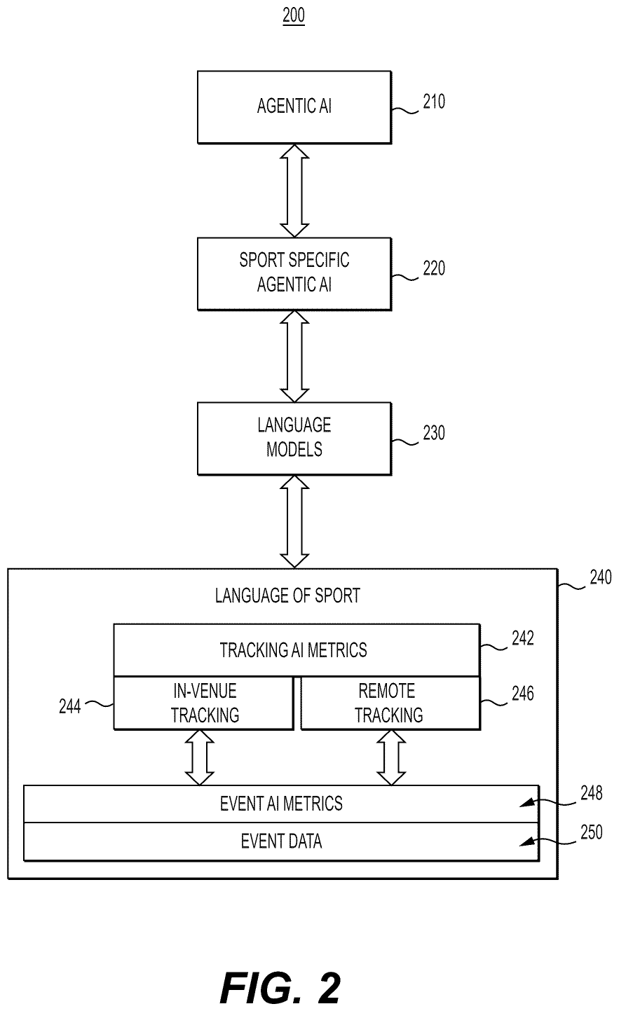

In some embodiments, the superior orchestrator of the orchestration module 124 may include a separate mapping model tuned for each input type (e.g., audio, text, drawing, video, etc.). Given that each input is very different from each other, there may be times that a single mapping model may have trouble determining connections and/or associations. In such scenarios, one or more individual mapping models may be employed for a single user input. For example, upon receiving a user input (e.g., speech and drawing), orchestration module 124 may utilize one or more mapping models for each input type received. The one or more mapping models may determine one or more connections and/or associations from the received inputs. Based on the determined one or more connections, orchestration module 124 may output one or more graphics and texts and/or perform actions corresponding to the user inputs (e.g., by activating a respective sport specific orchestrator and corresponding agents). Orchestration module 124 is discussed further in conjunction with figures discussed below (e.g., FIGS. 2-8).

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to access one or more determined connections and/or associations based on a user input generated by the orchestration module 124. The content that is displayed to client device 108 may be transmitted from web client application server 114 to client device 108, and subsequently processed by application 130 for display through a graphical user interface (GUI) of client device 108.

### Prediction Engine

A prediction engine may be configured to predict an underlying formation of a team. Mathematically, the goal of a role-alignment procedure may be to find the transformation A:{U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions

$${U}_{n} = {[ {x}_{s , n} ]}_{s = 1}^{S}$$

for an agent n∈[1, N] and a frame s∈[1, S]. In some embodiments, M may represent the optimal permutation matrix that enables such an ordering. The goal of the prediction engine may be to find the most probable set of [symbol] of two-dimensional (2D) probability density functions:

$$ℱ *= arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$$ℱ *= arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions

$${U}_{n} = {[ {x}_{s , n} ]}_{s = 1}^{S}$$

for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U′₁, U′₂, . . . , U″ₙ}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of baseball, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] ={P₁, P₂, . . . , P_{K}}, where [symbol] may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

### Hash-Table/Playbook Learning

For retrieval tasks using large amounts of data, an embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in tennis (e.g., expected point value (“EPV”). Other predicted values can also be chosen for performance variables, such as probability of making a returning a volley/serve, probability of an ace on a serve, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Bottom-Up Approach

In an embodiment of the system, a bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if the match is for doubles, what is the distance between his/her teammate, as well as the distance from the opposing teammates). Using this approach avoids the need to exhaustively check all distances, which is enormous for tennis.

### Top-Down Approach

In another embodiment of the system, a top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task-e.g., goal-scoring (Layer 3).

### Personalization Using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest—whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth.

### Machine Learning for Team or Player Predictions

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity

### Sports Machine Learning Models

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a tennis based sports machine learning model may be trained to correlate or otherwise associate player position information in reference to a tennis. The tennis based sports machine learning model may further be trained to correlate or otherwise associate sports data in reference to a number of players and sports targets specific to tennis.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

Retrieval Augmented Generation (RAG) is the process of optimizing the output of a large language model to reference an authoritative knowledge based outside of its training data sources before generating a response. Accessible data for generic assistive tools have knowledge cut-off dates that require continuous updating to include more information. Assistive tools, for instance chatbots, may understand questions using LLM technology. For example, when a query is inputted by a user, the chatbot will look to accessible data for a response, if there is not enough information within the accessible dataset, the chatbot may utilize RAG. In doing so, a chatbot may use the internet to augment its knowledge base and find the answer. Using certified or verified websites, the chatbot can leverage the information found on the website and provide a response.

In such an implementation, websites may ingest the up-to-date data summarize data relevant to the users, and a chatbot may utilize this subset of data (e.g., summarized or modified data). This approach, however, requires indexing and storing information that may be outside the constraints of some LLMs (e.g., context length being predefined). Also, this approach may not be applicable during “live in-play” (e.g., what is happening at the precise second of the game). This may be because the approach may have issues of latency, which are caused by website not having the available information at the time of occurrence.

One or more embodiments may utilize one or more of match statistics, textual insights, predictions (e.g., team and player at the match level, and team at the season level), graphics, video overlays, and player and ball tracking data. For example, tracking data may be generated using an in-venue feed or a broadcast feed. The tracking data may be supplemented with event data which may be provided by an operator or an automated system based on the events related to a given sport within a venue or via a broadcast feed. The tracking data and/or event data may be used to generate insights such as match statistics, textual insights, predictions, graphics, video overlays, and or the like. Accordingly, the tracking data and insights generated in accordance with the subject matter disclosed herein may be specific to a given sporting event and/or the sport associated with the sporting event.

A Retrieval Augmented Generation (RAG) approach (e.g., additionally or optionally utilizing a specific LLM trained for a sport, or fine-tuned LLM, or via prompt engineering) may be implemented based on training one or more generative models (e.g., generative learning models or large language models). The RAG approach may be implemented by first training a generative model using historical or simulated tracking data or insights associated with a given sport. The tracking data and/or insights may be related to the given sport and generated in accordance with techniques disclosed herein. Accordingly, the generative model may be a sports specific model for a given sport such that it is optimized to generate outputs for that given sport.

A production version of the generative model may be implemented by receiving a live data feed being processed during a given match. The live data feed may include tracking data and/or insights generated based on the tracking data. The live data feed may serve as a base of information provided to the generative model. The live data feed may be provided in any applicable format applicable to the generative model such as, for example, files that include data in key-value pairs, arrays, relations, matrixes, and or the like. Alternatively, or in addition, the generative model may convert data associated with a live data feed into a format that can be applied to generate generative model outputs by the generative model.

Therefore, the generative model may be trained using training data associated with a given sport and/or may be used by being provided a live data feed for a sporting event of the given sport. Accordingly, the generative model may be trained and used as a specialized model configured to generate nuanced outputs specifically for the given sport.

By using such a specialized generative model for a given sport, a user may be able to ask a question (via input) in a natural language and receive a response (e.g., via a display) in a natural language. Additionally, a user may input a query and generate content such as an image, video overlay, video animation, and/or the like. For example, a user may use such a specialized generative model to input a query related to the given sport associated with the specialized generative model. The specialized generative model may generate an output based on its training (e.g., using training data for the specific sport) and further based on one or more live data feeds associated with a match in that given sport. Based both on the training and the information available to the specialized generative model for the given sport, the specialized generative model may output a targeted output that is verifiable and meets an accuracy threshold not available via conventional techniques.

FIG. 2 depicts an exemplary flowchart for agentic artificial intelligence (AI) selection, according to example embodiments. Flow 200 may be part of the orchestration module 124 as described above with respect to FIG. 1. Flow 200 may include agentic AI 210, sport specific agentic AI 220 (e.g., a sports specific orchestrator as discussed herein), language models 230, and language of sport 240. Agentic AI 210 may be referred to as a superior orchestrator 210. The superior orchestrator 210 may be configured to receive a user input, the input including a description, and determine contextual and intentional information relating to the user input based on the description. The superior orchestrator 210 may determine contextual and intentional information by extracting one or more metadata items relating the description and determining at least one keyword or tag associated with the description. The superior orchestrator may further be configured to select one or more sport specific orchestrators (e.g., 220). The superior orchestrator 210 may oversee the performance of an action or set of action relating to the user input. For example, upon receiving the user input (e.g., text, audio, video, drawing, etc.) the superior orchestrator 210 may determine contextual and intentional information associated with the description of the user input. The superior orchestrator 210 does this to allow for a selection of one or more sport specific orchestrators. For example, if a user's inputs relates to Novak Djokovic at Wimbledon, the superior orchestrator may determine the user is requesting information about a specific player “Novak Djokovic,” while competing at “Wimbledon,” and the sport of tennis. The superior orchestrator 210 may then select a tennis specific orchestrator based on the determined contextual and intentional information.

Sport specific agentic AI 220 or sport specific orchestrator 220 may be trained to select one or more agents to perform an action based on the user inputs. The sport specific orchestrator 220 may be train using a sport specific language. The sport specific orchestrator 220 may be configured to select the one or more agents based on the sport specific language and the corresponding attributes, described in further detail below.

Language models 230 may include one or more sport specific languages, where each sport language is specific to a particular sport. Language models 230 may be used to train the sport specific orchestrator 220. Language of sport 240 may include one or more components including tracking AI metrics 242, in-venue tracking 244, remote tracking 246, event AI metrics 248, and event data 250. The one or more components of the language of sport 240 may relate to one or more components of computing environment 100 as described above with respect for FIG. 1. For example, tracking AI metrics 242 may be substantially similar to tracking data system 116 and configured to generate and derive player tracking data from broadcast feeds. In-venue tracking 244 may be substantially similar to tracking system 102, utilizing in-venue devices to capture the motions of one or more agents (e.g., players) on the playing surface, as well as one or more other agents (e.g., objects) of relevance (e.g., ball, puck, referees, etc.). Remote tracking 246 may be configured to capture player and ball tracking information from the broadcast video (e.g., broadcast data). For example, remote tracking 246 may identify and track one or more players in a broadcast video of a current game/match and map the information in the real-world coordinates, for example, on the pitch, court, or field as opposed to the location within the broadcast video. Event AI metrics 248 and event data 250 may be substantially similar to the event and/or tracking described herein. Each of the one or more components of the language of sport 240 may determine a sport specific language. For example, a sport specific language may be based on sport generic attributes and sport specific attributes. Sport generic attributes may be attributes that may apply to more than one sport. For example, sport generic attributes may include team versus individual, the number of players, the type of surface/field, the object played in play, or the like. Sport specific attributes may be sport specific, for example, the type of line-up, whether the game is possession based, how the game time is determined, what are the available results, or the like. Accordingly, a sports specific orchestrator (e.g., sport specific agentic AI 220) may be trained using a training data set for that specific sport, such that it is trained based on the rules, context, and nuances of that specific sport.

For example, tennis may include one or more sport specific attributes including, but are not limited to individual or doubles match (e.g., limited to one or two players per side), surface type (e.g., grass, clay, etc.), scoring method (e.g., score while in possession), possession based (e.g., switching possession each game/set), the result of the match can end in a win, or tie/draw, tactical considerations (e.g., baseline plays, serve and volley, approach, etc.). Each of the sport specific attributes may be used when determining event and/or tracking data (e.g., tracking AI metrics 242) from in-venue tracking 244 and remote tracking 246. The sport specific language model (e.g., tennis) may be generated based on training on that sport's sport specific attributes as discussed herein. The sport specific orchestrator 220 may be trained using a single sport specific language. The sport specific orchestrator 220 may then be configured to determine and select the one or more agents for perform an action or set of action determined by the superior orchestrator 210 based on the description of the user input.

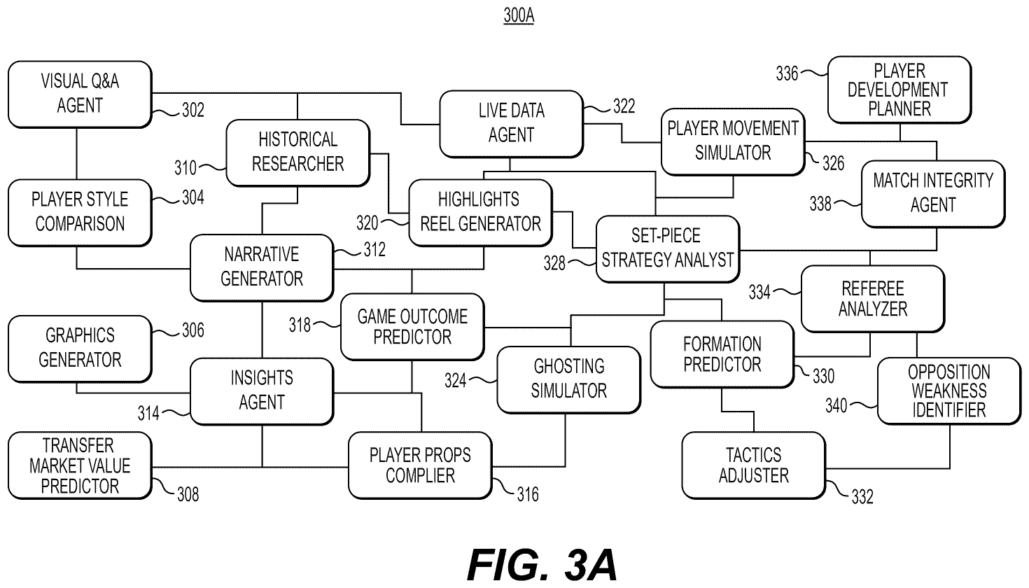

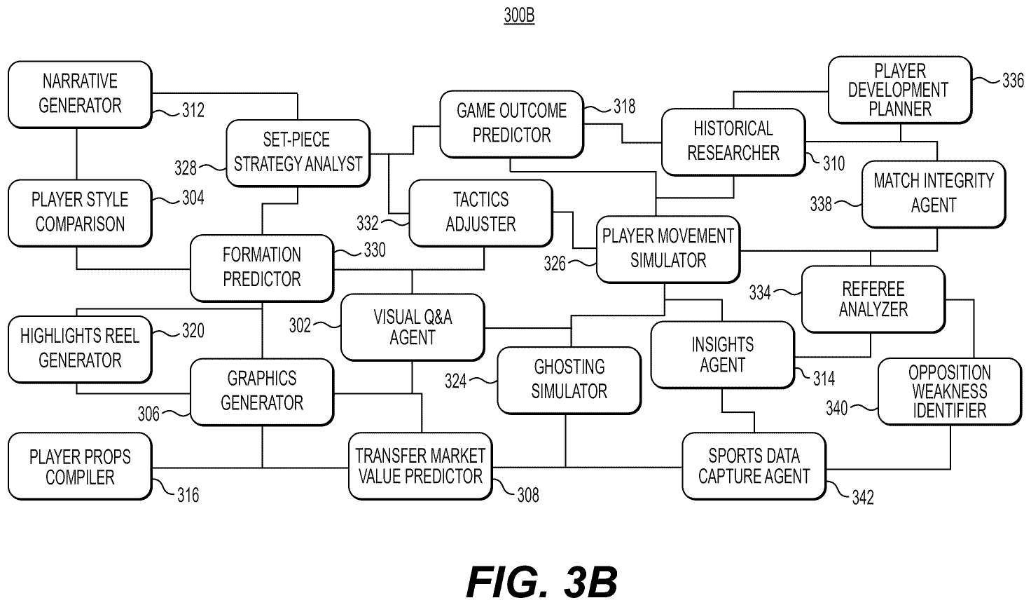

FIGS. 3A and 3B depict exemplary AI agents, according to example embodiments. Diagrams 300A and 300B depict one or more agents and their associated connections. Each agent may receive and transmit information from one another to retrieve and perform an action or set of actions based on the description of the user input. Each agent may be selected by a sport specific orchestrator 220 based on a determination by the superior orchestrator 210. The superior orchestrator 210 may oversee the sport specific orchestrator 220 and each of the selected agents performing the action or set of actions. The one or more agents may work with one another to gather, aggregate, and generate information and outputs relating to the action or set of actions determined by the superior orchestrator 210 and the sport specific orchestrator 220. According to embodiments disclosed herein, a first set of agents may be associated with a first sport and may be activated by a first sport specific orchestrator for that first sport. The first set of agents may be trained using a training data set for the first sport, such that it is trained based on the rules, context, nuances, and actions associated with that first sport. Similarly, a second set of agents may be associated with a second sport and may be activated by a second sport specific orchestrator for that second sport. The second set of agents may be trained using a training data set for the second sport, such that it is trained based on the rules, context, nuances, and actions associated with that second sport

The one or more agents may include visual Q&A agent 302, player style comparison 304, graphics generator 306, transfer market value predictor 308, historical researcher 310, narrative generator 312, insights agent 314, player props predictor 316, game outcome predictor 318, highlight reel generator 320, live data agent 322, ghosting simulator 324, player movement simulator 326, set-piece strategy analyst 328, formation predictor 330, tactics adjustor 332, referee analyzer 334, player development planner 336, match integrity agent 338, opposition weakness identifier 340, and sports data capture agent 342.

Visual Q&A agent 302 may be configured to provide one or more images, videos, play depictions, or other visual depictions in response to a question or query. The visual Q&A agent 302 may use computer vision to determine one or more images and/or videos to answer a user question. Player style comparison 304 may be configured to determine and provide a comparison of playing styles between one or more players and/or teams. For example, a player may be a defensive type player rather than an offensive type player. Graphics generator 306 may be configured to determine and provide one or more graphics based on the user inputs, for example, a graphical representation of a teams wins over a period of time in comparison to another team. Transfer market value predictor 308 may be configured to determine the value of an individual player being transferred or moved to another team. Transfer market value predictor 308 may be implemented using one or more prediction techniques disclosed herein. Transfer market value predictor 308 may provide an indication as to a worth, monetary or otherwise, a player may have with respect to a team. Historical researcher 310 may be configured to determine and gather historical information relating to a description of a user input. The historical information may relate to a specific point in time or a range relating to one or more players and/or teams. Narrative generator 312 may be configured to generate a narrative or story associated with the one or more players and/or teams corresponding to the user input. The story or stories may be generated based on historical, current, and/or predicted information. Narrative generator 312 may use one or more large language models to generate a narrative. Insights agent 314 may be configured to generate one or more insights (e.g., goals per match, minutes played, games won when playing, etc.) for one or more players and/or teams. Player props predictor 316 may be configured to determine a prediction for one or more players and associated market odds. The prediction may utilize the one or more of a player's current popularity, recent playing statistics, or the like. Game outcome predictor 318 may be configured to determine and predict the outcome of a game or match between two teams or players. The game outcome predictor 318 may further generate a prediction for a series or tournament between one or more teams. Highlight reel generator 320 may be configured to generate one or more graphics and texts relating to event data relating to one or more players or teams. For example, a highlight reel for Michael Jordan during his rookie season.

Live data agent 322 may be configured to retrieve live data information relating to one or more players, teams, and/or matches. The live data may be from live broadcast data from the in-venue tracking systems. Ghosting simulator 324 may be configured to generate a simulation of one or more scenarios and the associated outcomes related to game play. For example, ghosting simulator 324 may simulate positions and/or movement players and/or objects to generate tracking data while the players and/or objects are not visible (e.g., occluded or not present in a frame) in a feed used to generate the tracking data. As another example, the ghosting simulator 324 may provide simulated gameplay or tracking data based on a proposed on alternative input (e.g., simulation given a modified play, player position, player, etc.). Player movement simulator 326 may be configured to generate, using one or more player event and/or tracking data, a simulation of the player moving during a match with respect to another player or team. For example, simulating how Will Smith would move in a one-on-one match against Garrit Cole. Set-piece strategy analyst 328 may be configured to determine a particular play or tactical approach at each restart to a game based on the players, team, position, score, or the like. Formation predictor 330 may be configured to predict a formation of a team during a particular portion of game. For example, the formation predictor 330 may determine if a team is likely to run the next play in a shotgun or under-center formation when the team is down by seven points, with 2 minutes left in the half, and at the opposing twenty yard line. Tactics adjustor 332 may be configured to determine a set of tactics, plays, or formations to be implemented during a match based on one or more criteria. The tactics, plays, and/or formations may be dynamically updated based on historic, current, and predicted information. Referee analyzer 334 may be configured to analyze the impact of the referee on the current match or game, for example, whether the referee is favoring one or more players of a particular team. Player development planner 336 may be configured to assess a players abilities to determine their success in a particular league, with a particular team, or against particular player. Match integrity agent 338 may be configured to determine the integrity (e.g., fairness, transparency, or ethical conduct) of a game or match. Opposition weakness identifier 340 may be configured to determine one or more players, tactics, or formations that provide a weakness for a team. In addition, opposition weakness identifier 340 may determine one or more weakness of a particular player (e.g., strength, speed, agility, etc.). Sports data capture agent 342 may be configured to retrieve and aggregate sports data (e.g., plays, highlights, etc.) for a particular player or team.

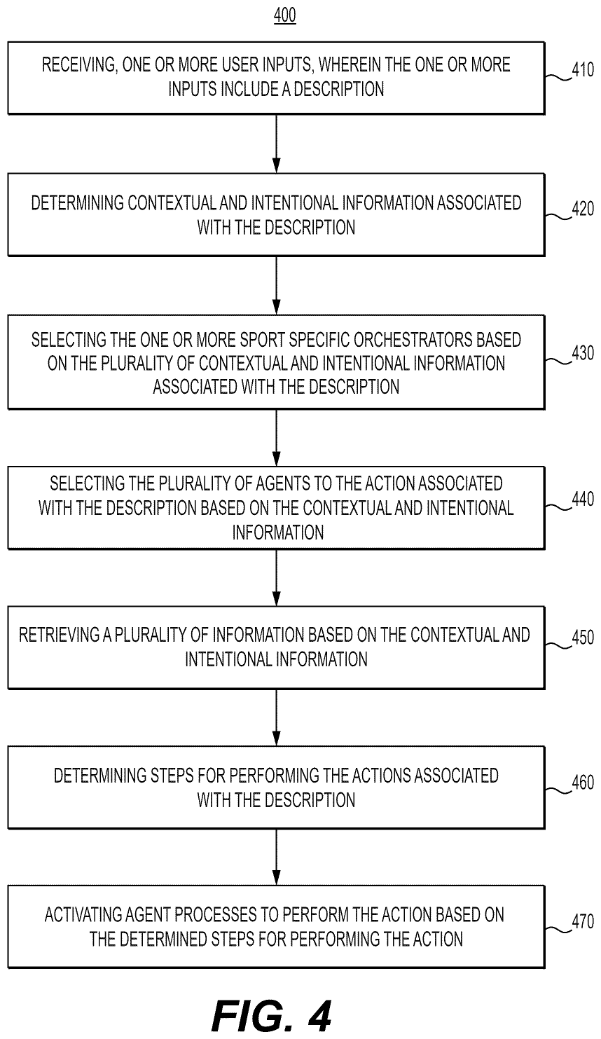

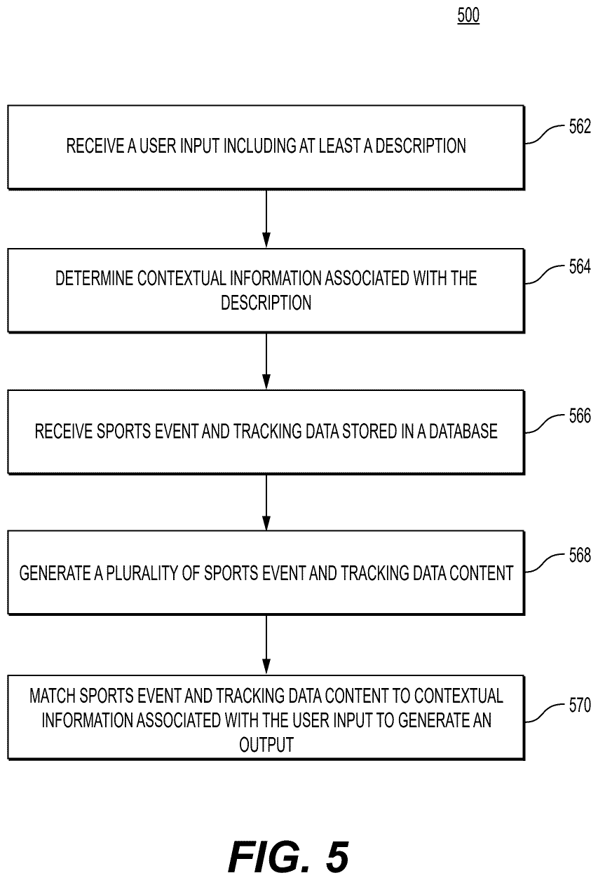

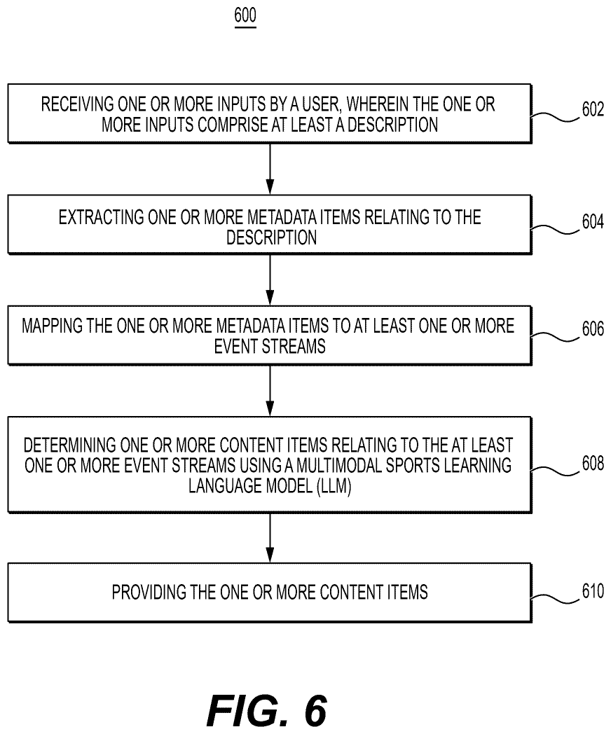

FIG. 4 depicts a flowchart of a method 400 for performing an action using agentic artificial intelligence (AI), according to example embodiments. At step 410, the method may include receiving one or more user inputs, where the user inputs include a description. The user inputs may include one or more of a text input, a drawing input, a video input, an audio input, an event stream input, or the like. The user inputs are further described in detail with respect to FIGS. 5 and 6 below. The description may include details and information relating to a player, a team, a league, a sporting event, or the like. At step 420, the method may include determining contextual and intentional information associated with the description. Contextual information may include relevant details that may assist in clarifying the circumstances of a query, a game (e.g., score, time, possession, momentum shifts, etc.), a team, a player (e.g., name, location, history, etc.), player performance (e.g., statistics, injuries, fatigue, form historical performance, etc.), or strategic decisions (e.g., lineups, coaching, decision, chemistry, etc.). Intentional information may include data and/or insights reflecting a query, a player's or team's deliberate actions, goals, or strategies behind the decision or event. Intentional information may further include purpose driven information, decision based information, or strategic or planned information. Determining contextual and intentional information may include extracting one or more metadata items relating to the description and determining at least one keyword or tag associated with the description. The one or more metadata items may include information to assist the superior orchestrator 210 to determine the one or more sport specific orchestrators 220 and the corresponding plurality of agents (e.g., as determined by a sport specific orchestrators 220). The at least one keyword or tag associated with the description may include words or phrases that may indicate particular players, teams, events, or actions requested by the user based on the description.

At step 430, the method may include selecting the one or more sport specific orchestrators (e.g., sport specific orchestrator 220) based on the plurality of contextual and intentional information associated with the description. For example, a user query of “Provide highlights of Novak Djokovic for the last two years during Wimbledon.” The superior orchestrator may receive the input(s) and determine the associated contextual and intentional information. The contextual information may include the output, “highlight,” of a particular player, “Novak Djokovic,” during a particular period of time, “most recent two years,” for while competing at, “Wimbledon.” The intentional information may include how the highlights are presented to the user, for example, a series of plays, aces, volleys, wins, or the like. The intentional information may be determined based on the description of the user input in addition to a user profile that may include past queries, output preferences, modifications, or the like. This additional information may assist the superior orchestrator in determining the action or set of actions to be performed relative to the description of the user input.

At step 440, the method may include selecting the plurality of agents for the action associated with the description based on the contextual information and the intentional information. Selecting the plurality of agents may include mapping or more metadata items to at least one or more event streams and determining at least one keyword or tag associated with the one or more metadata items to the at least one or more event streams. As discussed above with the respect to FIGS. 3A and 3B, each of the plurality of agents may be configured to perform one or more actions. Each of the plurality of agents may work with one another to gather, aggregate, or generate the information requested by the user. The superior orchestrator and/or the sport specific orchestrator may utilize the one or more metadata items, event streams, keywords, or tags to determine which of the plurality of agents have been trained to perform the specific actions requested (e.g., either alone or in conjunction with two or more agents). In one embodiment, the superior orchestrator and/or the sport specific orchestrator may determine the plurality of agents based on sport generic attributes and sport specific attributes as discussed herein. The superior orchestrator and/or the sport specific orchestrator may determine the plurality of agents based on a threshold of sport specific attributes determined based on the keywords, tags, metadata items, or the like. When the threshold for sport specific attributes for a specific sports language is exceeded, the sport specific orchestrator may select a plurality of agents corresponding to that particular sport.

At step 450, the method may include retrieving a plurality of information based on the contextual information and the intentional information. Upon the superior orchestrator selecting one or more sport specific orchestrators, each sport specific orchestrator may then select the plurality of agents to perform the action or set of actions relating to the user input. Each agent may be trained to retrieve particular information based on the action(s) assigned to each agent, for example, one or more sports tracking data and one or more sports event data.

At step 460, the method may include determining steps for performing the action associated with description of the user input. Performing the action may include generating one or more sports content based on the information received and the one or more agents may be configured to execute instructions for matching the at least one keyword or tag associated with the description to the at least one keyword or tag relating to the at least one or more event streams. Generating the one or more sport content may include retrieving one or more content items relating to a subset of the at least one or more event streams. For example, the superior orchestrator and/or the sport specific orchestrators may determine the type of content (e.g., descriptions, videos, summaries, etc.) that have been indicated from the contextual and intentional information. Based on these decisions, the orchestrators can select the appropriate action(s) to be performed and the corresponding agent(s) to perform each action.

In another example, the superior orchestrator and/or the sport specific orchestrators may determine a match analysis is requested to determine the effect the referee may have had on the match result based on the contextual and intentional information. The orchestrators can select the appropriate action(s) (e.g., historical matches and outcomes for a period of time including a particular referee and/or team/player combination) to be performed and corresponding agents (e.g., referee analyzer 334) to perform each action.

In a further example, the orchestrator and/or the sport specific orchestrators may determine a game prediction is requested based on the contextual and intention information. The orchestrators can select the appropriate action(s) (e.g., retrieve historical match data for each team, player comparison for each team, situational results based on historical game information, etc.) to be performed and corresponding agents (e.g., game outcome predictor 318) to perform each action.

In an additional example, orchestrator and/or the sport specific orchestrators may determine a transfer market value prediction for a particular is requested based on the contextual and intention information. The orchestrators can select the appropriate action(s) (e.g., determine player, determine team current makeup, team ranking with/without player, player impact, etc.) to be performed and corresponding agents (e.g., transfer market value predictor 308) to perform each action.

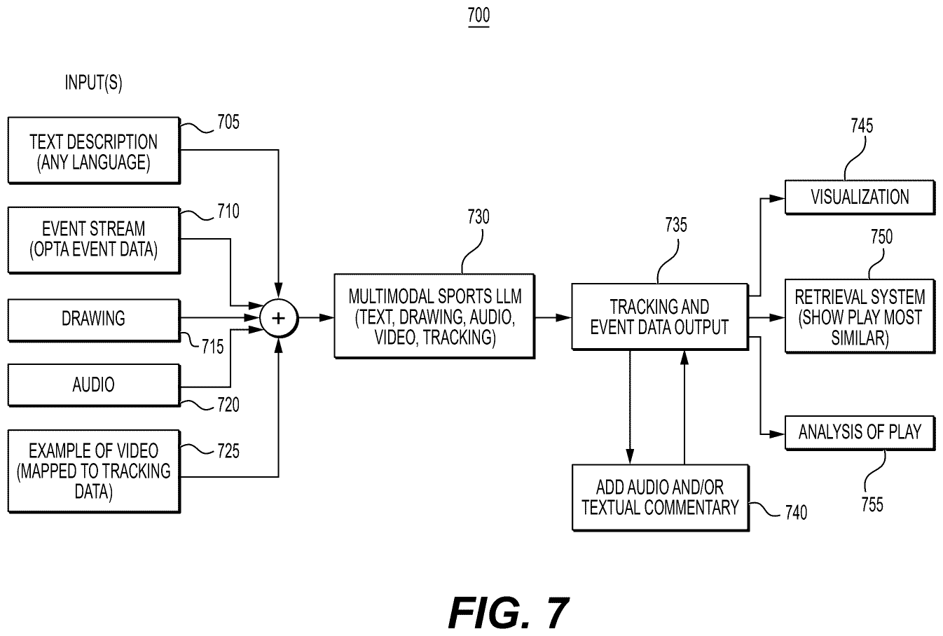

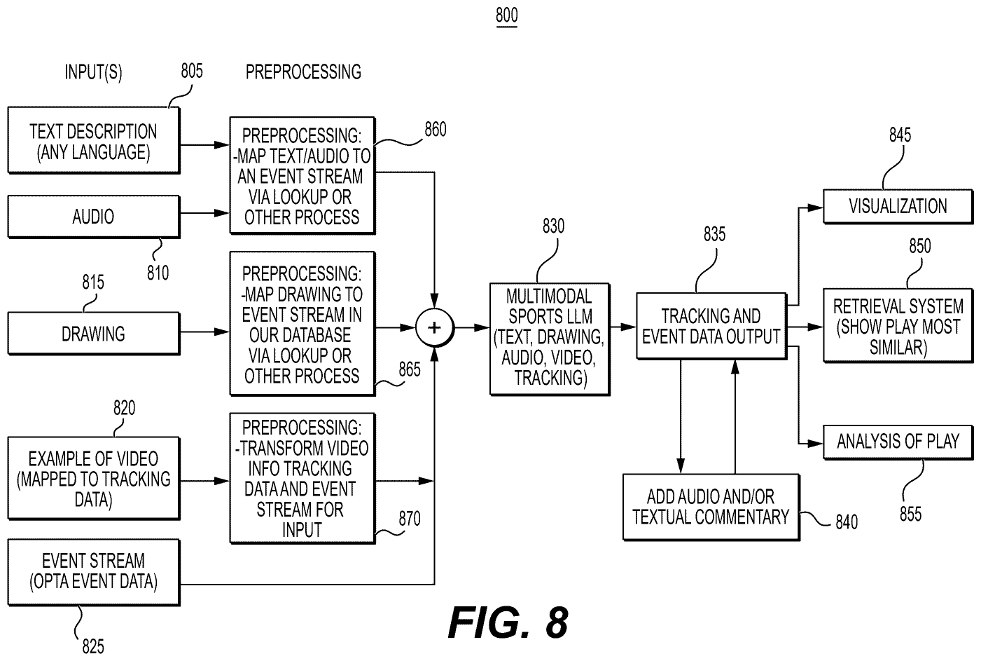

At step 470, the method may include activating the agent processes to perform the action based on the determined steps for performing the action. For example, using the example above, the user query of “Provide highlights of Novak Djokovic while competing at Wimbledon” may determine a set of actions and the steps for performing the set of actions. The actions may include retrieving information relating to Novak Djokovic, the information being in the form of plays, aces, volleys, wins, or the like. The information may further be defined as “highlights” to distinguish from normal plays or sports event including Novak Djokovic. The information may be subject to a specific time period, last two years, while competing at Wimbledon. In addition, the steps for performing the action(s) may include aggregating the information retrieved and to generate a montage or reel based on the information (e.g., sports content items). Each of the agents selected by the sport specific orchestrator may then perform each action determined by the superior orchestrator and/or the sport specific orchestrator. Upon completion of the action(s), the plurality of agents may provide the sports content items to the superior orchestrator for review. The superior orchestrator may further request additional information and actions based on the sports content items presented by the plurality of agents. The superior orchestrator may further provide the sports content items to user device of the user. The presentation of the sports content items may be described in further details with respect to FIGS. 7 and 8 below.

In another example, based on a request for how a current player will impact a league, the superior orchestrator may have determined a plurality of actions to be performed by one more agents. The agents may then, for example, retrieve historical player information, player statistics, current and predicted market value, coachability information, or the like. Each agent may perform the one or more actions based on the request from the superior orchestrator and/or the sport specific orchestrators. Each agent may gather and aggregate the information and generate an output for review by the superior orchestrator.

In a further example, based on a request for determining an opponent weakness for an upcoming match, the superior orchestrator may have determined a plurality of actions to be performed by one more agents. The agents may then, for example, retrieve player/tram statistics, results for each match between the players/teams, playing style information for each player/team, or the like. Each agent may perform the one or more actions based on the request from the superior orchestrator and/or the sport specific orchestrators. Each agent may gather and aggregate the information and generate an output for review by the superior orchestrator.

FIG. 5 depicts a flowchart of a method 500 for generating an interactive display for a sports content data stream, in accordance with an aspect of the disclosed subject matter. At step 562, a user input including a description (e.g., query) may be received. The description may be received via a text input, an audio input, a video input, a drawing input, a gesture input, and/or the like. The user input may be a description request related to a sporting event, a team, a player, and/or the like. At step 564, contextual information associated with the description may be determined. As discussed herein, a generative machine learning model (e.g., superior orchestrator 210) may receive the description as an input and may output the contextual information based on the description. The contextual information may be correlated with sporting event data and/or with content generated based on the sporting event data.

At step 566, sporting event and tracking data may be received and stored in a database. The sporting event and tracking data may be automatically generated based on a broadcast or in-venue feed and may include player and/or object position information, movement information, trends, changes, and/or the like. As discussed herein, a sport specific orchestrator (e.g., sport specific orchestrator 220) may determine and select a plurality of agents to perform one or more actions associated with the description based on the contextual information and intentional information. In one embodiment, the plurality of agents may retrieve sports event and tracking data stored in the database.

At step 568, a plurality of sports event and tracking data content (e.g., graphics, statistics, displays, images, videos, etc.) may be generated based on the sports event and tracking data received at step 566. In addition, advertising and/or odds based content may also be generated based on user preferences and/or the sports event and tracking data received at step 566. As discussed herein, the plurality of agents may be configured to generate sport content items incorporating the retrieved sports event and tracking data.

At step 570, sports event and tracking data content may be filtered by matching such content to the contextual information associated with the user input received at step 562. The matching may be performed by a machine learning model (e.g., plurality of agents) that receives, as inputs, the sports event and tracking data content, the contextual information, and/or user preference information. At step 570, a subset of the content generated at step 568 may be output to a user one or more sports content items. The sports content items may include one or more of sports information cards, sports media stories, sports comparison graphics, or sports media that a user may passively consume or may interact with (e.g., to access additional content, place a wager, access a webpage or application, etc.).

FIG. 6 depicts an example flowchart of a method 600 for generating tracking and/or event data, in accordance with an aspect of the disclosed subject matter. At step 602, one or more inputs by a user (e.g., a user query) may be received. The one or more inputs may include a description of a sporting action (e.g., a play) and may be in a text format, audio format, visual format, event/tracking data format, or the like, as discussed herein (e.g., in reference to FIGS. 7 and 8).

At step 604, one or more metadata items related to the description may be extracted. The one or more metadata items may correlate aspects of the description with features that can be mapped to an event stream. An event stream may be historical or simulated tracking and/or event data determined based on a broadcast or in-venue sports stream. Accordingly, at step 604, a user input query (e.g., description) may be translated into a format that allows mapping the input query to an event stream. As discussed herein, a superior orchestrator (e.g., superior orchestrator 210) may receive the user inputs and determine contextual information and intentional information by extracting one or more metadata items associated with the description of the user input. The contextual information and the intentional information may assist the superior orchestrator determine which of the one or more sport specific orchestrators may be required to perform a set of actions. The contextual information and intention information may provide additional details as to the potential output and/or actions included in the user input.

At step 606, the metadata items may be mapped to one or more event streams, as further discussed in reference to FIG. 8. The mapped event stream and/or contextual information may be provided to a multimodal sports LLM model. In some embodiments, the mapping metadata to the event streams may be performed by a superior orchestrator. The mapped information may assist in determining which of the sport specific orchestrators may be required for performing the one or more actions include in the user input.

At step 608, one or more content items that relate to the one or more mapped event streams may be output by the multimodal sports LLM. As discussed herein, the multimodal sports LLM may be trained to output actual or generated event and/or tracking data that correlate with the event streams mapped at step 606. The mapped event streams may provide features, criteria, and/or boundaries for the information requested via the user query, in a format that allows multimodal sports LLM to output a response to the query. In one embodiment, the plurality of agents selected by the sport specific orchestrator may retrieve and generate the outputs of actual or generated event and/or tracking data corresponding to the event streams.

At step 608, the one or more content items output by the multimodal sports LLM may include actual or generated event and/or tracking data in response to the user query. The actual or generated event and/or tracking data may include player and/or object position information, movement information, trends, changes, and/or the like in response to the user query. In addition, the one or more content items output may include one or more actions based on the actual or generated event and/or tracking data.

At step 610, the actual or generated event and/or tracking data output by the multimodal sports LLM may be provided to the user (e.g., via a user device). The output may be provided as a visual display depicting the player and/or object position information, movement information, trends, changes, and/or the like in response to the user query. For example, the player and/or object information may be provided in a video format that depicts a play corresponding to the player and/or object information. The video may progress from the beginning to an end of the play and may include indicators representing the player and/or object information. As another example, the player and/or object information may be provided in an image format. The image may depict player and/or object information over the course of a given play. In one embodiment, the plurality of agents may perform one or more actions related to the metadata items relating to the description of the user input. For example, the plurality of agents may place market odds, update a user stream and/or interface, record an upcoming match, buy tickets, make reservations, or the like.

In one embodiment, a user query may relate to providing a play-by-play analysis for a current match. The system may retrieve one or more current broadcast streams (e.g., via live data agent 322) and provide a textual description (e.g., via narrative generator 312) for the content of the match. In addition, the play-by-play description may include a prediction (e.g., via game outcome predictor 318, player style comparison 304, player movement simulator 326, or the like) of each touch by one or more players, for example, whether a current play will pass, shoot, lose possession based on the circumstances of the current match.

In one embodiment, a user query may relate to predicting the outcome of a current match. The system may receive one or more current broadcast streams (e.g., via live data agent 322) and/or historical match information (e.g., via historical researcher 310 and player style comparison 304). The system may further predict an outcome based on the first half of the match (e.g., via insights agent 314, game outcome predictor 318, set-piece strategy analyst 328, opposition weakness identifier 340, or the like) and generate an output (e.g., via graphics generator 306 or visual Q&A agent 302) for the display to the user.

FIGS. 7 and 8 depicts flow diagrams of an exemplary method for using the machine-learning model to perform actions, in accordance with an aspect of the disclosed subject matter. FIG. 7 describes an exemplary method exemplary method 700 for using a machine-learning model. The method 700 starts with receiving user inputs from a client device (705-725). The inputs may be in the form of text description 705, event stream 710, drawing 715, audio 720, or video 725. For example, client device 108 may execute application 130 and provide a user interface for entering one or more inputs. The user interface may include a dialogue box for inputting, via drag and drop, one or more of text, images, video clips, audio chunks, or the like. In addition, the dialogue box may include an interface object for capturing live audio and/or video from the user. Additional inputs may be received throughout the process to further refine the query.

Based on the received input(s), the system (e.g., orchestrator module 124 and/or superior orchestrator 210) may determine contextual and intentional information to describe the sports information requested. The contextual and/or intentional information may be defined at the time of the received input(s), for example defined by the user in addition to the query, and/or the contextual and/or intentional information may be inferred by the one or more models. For example, the user may input a query or a question using one or more inputs as described above, the query may include contextual and/or intentional information. The orchestration module 124 may be configured to use one or more mapping models based on the input type(s) to determine contextual and intentional information from the received input(s). Each mapping model used may be trained for the specific input type, for example, a drawing interface may be mapped to a textual question, an event stream, tracking data, an image, video, or the like. The drawing mapping model may be configured to receive user input in a first format (e.g., drawings) and transform the received input into a second format (e.g., game files 126) usable by the multimodal sports LLM. The input received by the multimodal sports LLM may be configured to infer contextual and/or intentional information based on the inputted query. If the contextual and/or intentional information is received as part of the query, the multimodal sports LLM may further compare the entered contextual and/or intentional information to the inferred contextual and/or intentional information to determine the accuracy of the multimodal sports LLM. The multimodal sports LLM may use the comparison of the contextual and/or intentional information to modify the training of each additional multimodal sports LLM to generate a more accurate inference for future inputs. In addition, the system may further include a conversation layer configured to clarify or request additional information from the user to determine the contextual and/or intentional information relating to the inputted query.

Based on the contextual and intentional information, the method 700 may determine sports event and/or tracking data that matches the inputs received using the multimodal sports LLM 730. As described herein, the multimodal sports LLM 730 may be part of the orchestrator module 124. The orchestrator module 124 via the superior orchestrator 210 may determine, based on the contextual and intentional information one or more connections and/or associations to one or more sports event and/or tracking data. The sports event and/or tracking data may include present and/or historical information related to individual players and/or teams. Upon the one or more sports event and/or tracking data being determined, the system via the plurality of agents may output the sports event and/or tracking data to the user's client device (735) (e.g., client device 108). The system may present the sports tracking data and events in one or more of audio and/or text commentary 740, visualizations 745, similar plays 750, and play analysis 755. For example, based on a user query (e.g., text or audio) to display the highlights of the doubles matches, limiting the highlights to Wimbledon. The mapping module 124 may determine contextual and intentional information associated with the query and determine connections and associations to sports tracking data. Upon retrieving the sports tracking data from tracking data system 116 and/or data store 118, the system may output one or more clips of each ace scored during a doubles match during Wimbledon. In addition, the user may input further modifiers or queries to refine the contextual and intentional information to further narrow the selected sports tracking data.

FIG. 8 depicts an alternative technique for outputting tracking and event data. FIG. 8 describes an exemplary method exemplary method 800 for using a machine-learning model. As similarly described in FIG. 7, user inputs may be received (e.g., 805, 810, 815, 820, and 825). Based on the received inputs, a preprocessing procedure may take place (e.g., 860-870). The preprocessing may augment the received inputs by determining what sports tracking data events are being requested via the user query. For instance, the system can determine the context of the query entered by the user during the preprocessing procedure. In addition to context, the system may identify the intent behind the query, for example a question posed by the user. With this additional information, the system can better map or match sports tracking data using the multimodal sports LLM (830). As described above, the system then outputs the sports tracking data and events (835) and presents the sports tracking data and events to the user in a plurality of manners (e.g., 840, 845, 850, and 855).

Preprocessing (860-870) may include mapping text and/or audio inputs to an event stream (e.g., using a database lookup or other identification process). Accordingly, during such preprocessing, text and/or audio inputs are converted into a tracking and/or event data format that may be provided to the multimodal sports LLM to more efficiently correlate with historical event and/or tracking data in order to generate output event and/or tracking data. As described above with respect to FIG. 7, the orchestrator module 124 via the superior orchestrator 210 may perform some or all of the functions associated with preprocessing (860-870). Similarly, preprocessing (860-870) may include mapping visual data (e.g., a drawing, video data, tracking data, etc.) to an event stream (e.g., using a lookup or other identification process). Visual data may be analyzed and converted into a tracking and/or event data format that may be provided to the multimodal sports LLM to more efficiently correlate with historical event and/or tracking data in order to generate output event and/or tracking data.

As depicted in FIG. 8, input data (825) that is provided as an event stream may not require preprocessing as such data may already be in a format that may be provided to the multimodal sports LLM to more efficiently correlate with historical event and/or tracking data in order to generate output event and/or tracking data.

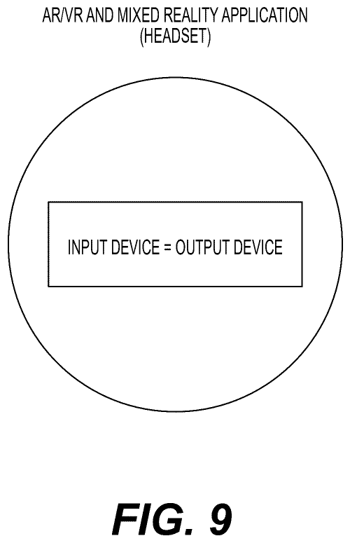

FIG. 9 depicts an example scenario of use within an AR/VR and mixed reality application (e.g., using a headset). An AR/VR and/or mixed reality device may be used to receive a user input and/or to provide the output tracking and/or event data to a user as described herein.

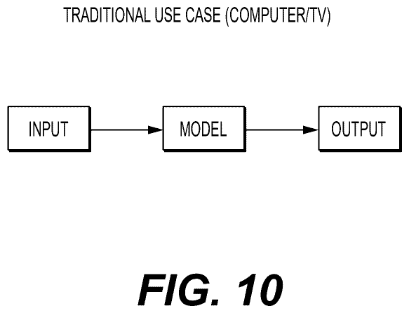

FIG. 10 depicts an example scenario of use where a user may utilize a personal computer or TV as the input/output device. For example, a user may use an AR/VR or other electronic device to provide the user input query (e.g., as depicted in FIGS. 7 and 8) to be used by a multimodal sports LLM to generate output tracking and/or event data.

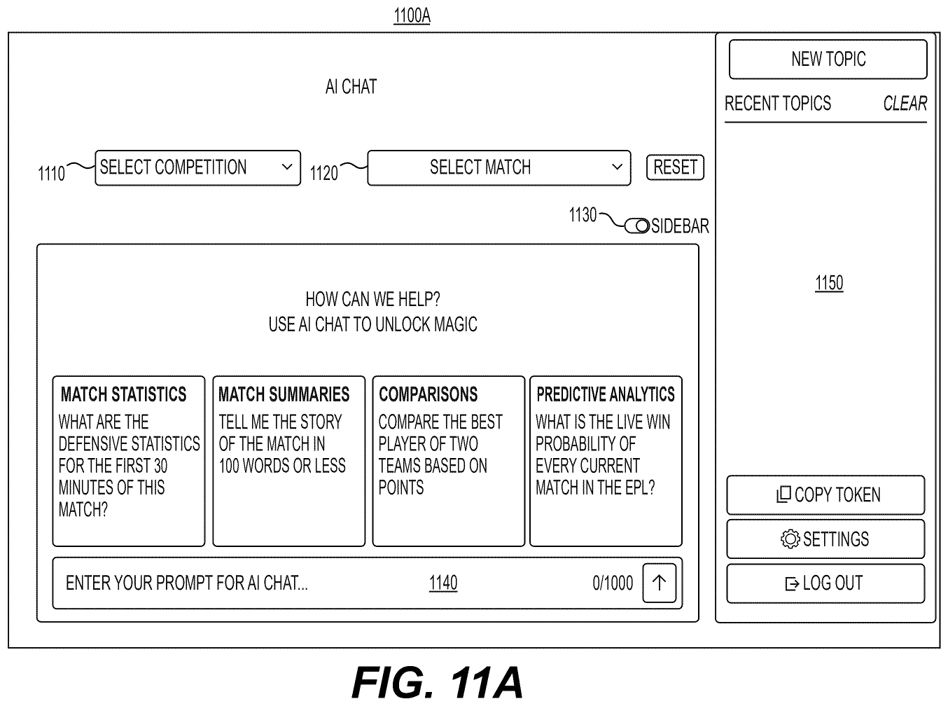

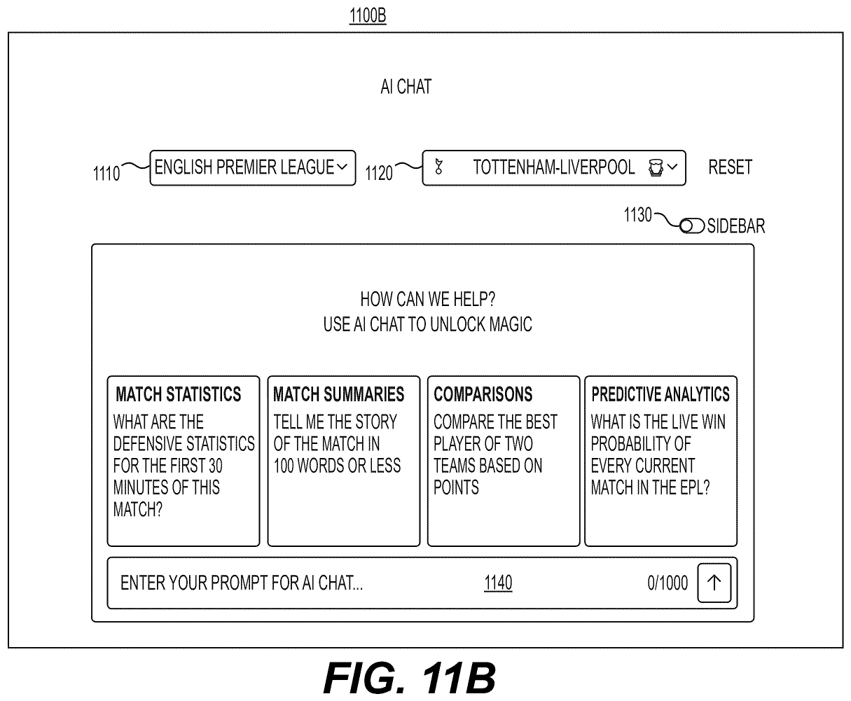

FIG. 11A depicts an exemplary input user interface, according to one or more embodiments. User interface 1100A may include a competition drop down 1110 configured to receive a user selection of a competition (e.g., a sport, a league, a tournament, etc.). Based on the competition being selected via the competition drop down 1110, a match drop down 1120 may be configured to populate based on matches associated with the selected competition. A user may select one or more matches via the match drop down 1120 and one or more live data feeds associated with the one or more matches selected may be provided to a selective generative model, as discussed herein. User interface 1100A may further include an input box 1140 configured to allow a user to input one or more prompts be used by the one more generative models. A user may utilize one or more inputs (e.g., text, audio, drawings, etc.), as described above with reference to FIGS. 7 and 8. User interface 1100A may include a side panel 1150 configured to allow a user to create one or more new topics such that queries or dialogues associated with previous topics of a search may be cleared. The side panel 1150 may include a toggle 1130 configured to display or hide the side panel 1150. Displayed in the side panel 1150 may include a list of recent topics to select from which may automatically populate the corresponding competition and/or match information selected from the competition drop down 1110 and/or the match drop down 1120.

FIG. 11B depicts user interface 1100B in response to the user selecting a competition and a match via the competition drop down 1110 and the match drop down 1120. In addition, the user has hidden the side panel 1150 via the toggle 1130. User interface 1100B may include one or more example query prompts to assist with query generation. For example, the example query prompts may be customized based on the selected competition, associated sport, and/or one or more matches selected. In addition, the example query prompts may be generated based on a user profile or historical information related to the user such as past prompts.

Conventional generative AI applications fall short when providing information relating to live sports. This is due to the limited access to live data-sources as well as subsequent enriched data sources (e.g., insights, graphics, and predictions). The specialized generative models discussed herein overcome these shortcomings by specialized training and/or by using live data feeds (e.g., based on tracking data and insights) and causing the specialized generative model to generate outputs based on the same.

Overcoming the disadvantages of conventional generative AI applications includes the use of live data-feeds being processed during a match. Using such a RAG-based approach, input data can be “digitized” such that a specialized generative model can utilize such digitized data to respond to an input query.

According to embodiments, a specialized generative model discussed herein may generate an output based on a user query. The user query may be a textual query, an audio query, a query generated based on a user profile, a query selected from a set of queries, and/or the like. An output may be a text output, an audio output, an image, a graphic, a video, and/or an interactive output. The specialized generative model may generate multiple outputs and/or may use a first output to generate a second output. For example, a first output may include a text description, summary, or raw data in response to a user query. Such a first output may be provided to a user and/or may be used to generate a second output. The second output may be, for example, an audio output, an image, a graphic, a video, and/or an interactive output. Such a second output may be generated based on the first output data and the tracking data and/or insights associated with a live data feed that the first output is based on. Further, content from an in-venue feed and/or broadcast feed may be correlated with the first output such that the second output includes the data associated with the first output as well as content pulled from the in-venue feed and/or broadcast feed.

For generation of content (e.g., an image, a graphic, a video, and/or an interactive output), necessary data may be extracted (e.g., from the live data feed) and then fed into a graphics API to generate the content. An advantage may include the use of live feeds to generate tracking data and/or analytics to implement a RAG based generative model. One or more embodiment may include the use of RAG and/or LangChain, for example. One or more embodiments may include the use of querying a local data-store using a text2SQL constrained to the live games of interest.

One or more embodiments may include training a generative model using historical or simulated tennis data. The tennis generative model may adjust weights, layers, biases, synapsis, and/or the like in accordance with events, patterns, relationships, and/or the like associated with tennis. For example, the tennis generative model may be trained with boundaries that include one individual per side (singles) or two individuals per side (doubles) per match, one ball, number of games and sets, an ace (a serve within the boundary without a return), a fault (hitting the net on a serve), a point (after a serve, a hit within the boundary without a return), implications of penalties, injuries, time-outs, and/or the like.

The tennis generative model may receive tennis specific live data feeds processed during one or more games. The tennis specific live data feeds may be provided by a RAG or LangChain system associated with tennis live data feeds. Alternatively, the tennis generative model may query a local data-store (e.g., using a text2SQL that is constrained to live or applicable games of interest). Information relating to the live-data feeds may include, for example, player location, ball location, number of game, number of set, penalties given, and number of games and/or sets remaining.

One or more embodiments may include a user inputting (e.g., talk, text, touch, etc., or a combination thereof) a tennis related query into a prompt. The tennis related query entered may relate to a player, score, match or a combination thereof of interest to the user. Once entered, the query may be used to select one or more available tennis specific live data feeds. The query may be analyzed using such live-data feeds and the tennis specific training associated with the tennis generative model, as discussed herein. Once analyzed, a response to the query may be generated and the user may be provided with an output (e.g., text, audio, video, or a combination thereof). The output may be supplemented with content obtained from a data store and/or a visual feed (e.g., a broadcast feed and/or in-venue feed).

As a specific example, a user may enter a query, via spoken word, relating to Novak Djokovic and his live match against Carlos Alcaraz at Wimbledon. A further prompt may be provided to assist the user in additional details of interest to the user. For example, a prompt requesting additional information of how output information should be displayed to the user. One or more live data feeds may be provided to the tennis generative model. Such live data feeds may be utilized by the tennis specific model to analyze information relating to Novak Djokovic, Carlos Alcaraz, Wimbledon, each player and their respective location on the court, score, match events, and more. Live data feeds from in-venue systems may track each player identified by the user query (e.g., Novak Djokovic) with player specific information (e.g., location, minutes played, aces, faults, etc.). The tennis generative model may generate an output based on its training and such live data feeds to respond to the query. Further, the response may be provided to a graphics API that may generate visual content associated with Novak Djokovic (e.g., an image of Novak Djokovic identified in the live data feed as a high engagement image). Outputted information from the graphics API may be in the form of visualizations, analyses, audio and/or textual commentary or a combination thereof based on the inputted query and/or additional prompt. For example, the initial query identified the player Novak Djokovic and an additional prompt identified a graphic visualization of Novak Djokovic with corresponding statistics throughout the match.

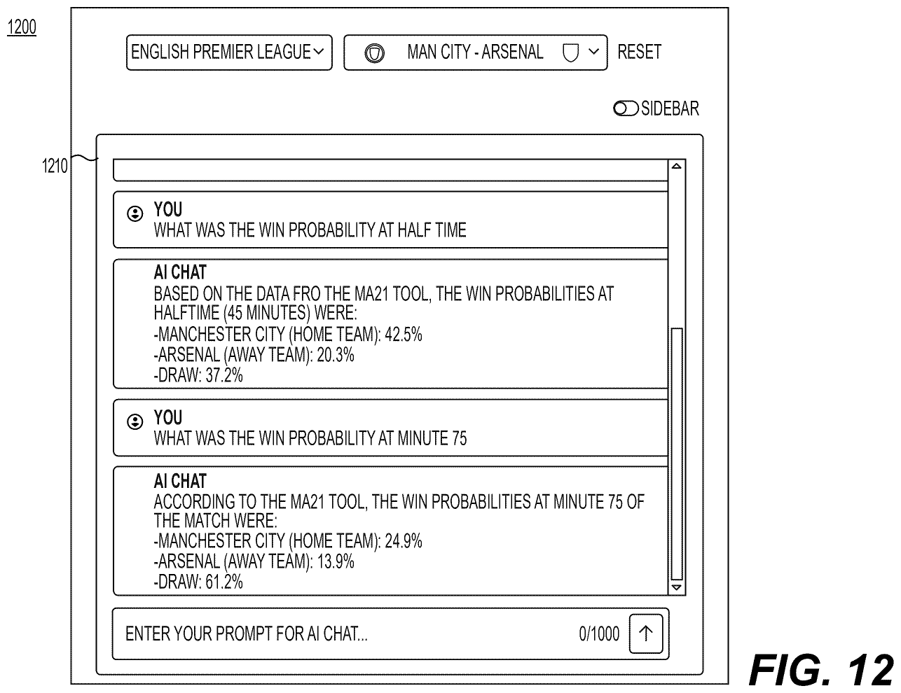

FIG. 12 depicts an example dialogue facilitated by a tennis generative model, according to one or more embodiments. Although a soccer-specific dialogue is shown, it will be understood that that the interface provided in FIG. 12 could similarly be applied to a tennis specific example. User interface 1200 may be configured to display one or more user prompts and responses based on the selected competition and match within a chat window 1210. The data feed may be based on applicable live data feeds and may include one or more depictions of user queries and responses generated using the tennis generative model discussed herein.

One or more embodiments may include a recommendation engine embedded in a chat window (e.g., chat window 1210) to assist a user. For example, the recommendation engine may learn from user behavior over time. The recommendation engine may automatically select one or more live data feeds based on the user's past queries. For example, if the user previously input queries related to a specific team, the recommendation engine may update a specialized generative model with live data feeds for new matches associated with that team.

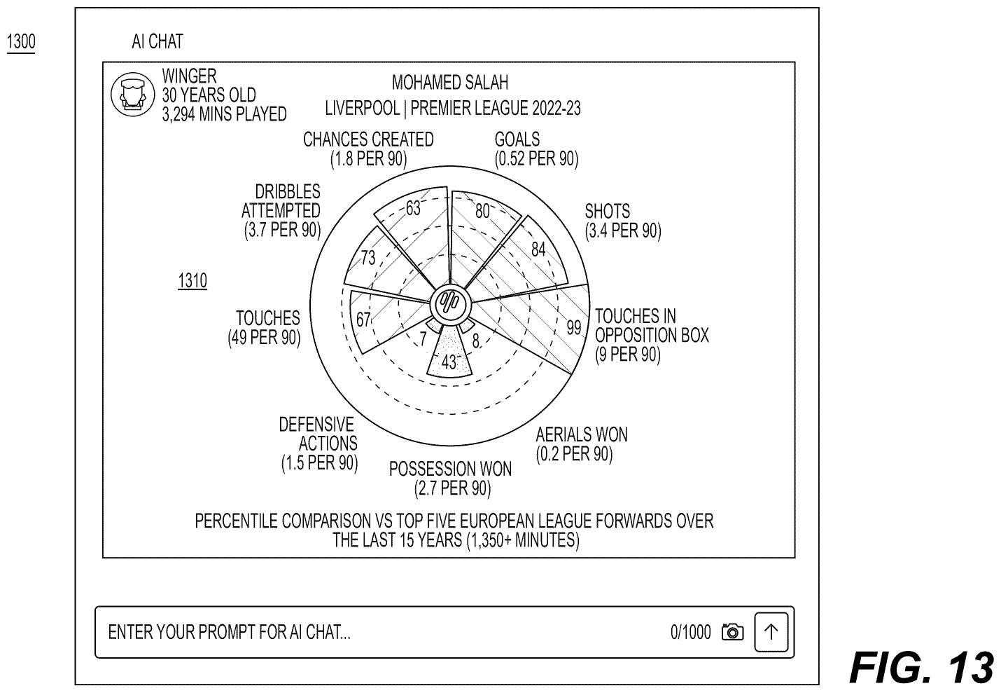

FIG. 13 depicts an example graphic output interface, according to one or more embodiments. Although a soccer-specific dialogue is shown, it will be understood that that the interface provided in FIG. 13 could similarly be applied to a tennis specific example. User interface 1300 may provide an exemplary graphic 1310 generated in response to a user query and applicable live data feed, as described above with respect to FIGS. 11 and 12. The graphic 1310 may correspond to the one or more inputted queries by the user. The exemplary graphic 1310 may include one or more of text, graphics, audio, video, or the like to convey the information requested by the user through the one or more queries. For example, the user may input text or audio as a user query. Based on the information determined by the system, a tennis generative model may be selected, as discussed herein. User interface 1300 may display graphic 1310 depicting analytic data corresponding to a tennis player that was the subject of the user query. The analytic data may be generated based on one or more live data feeds and the tennis specific training of the tennis generative model.

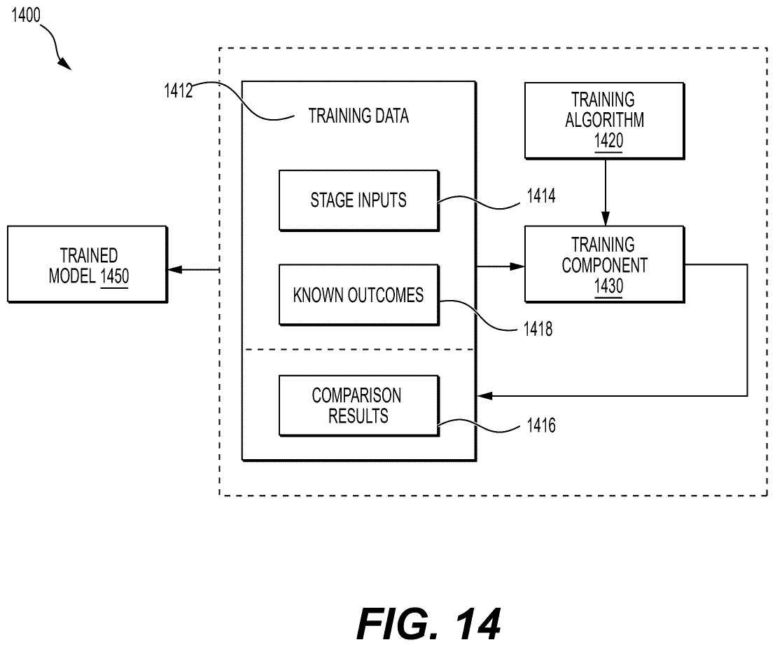

FIG. 14 depicts a flow diagram for training a machine learning model, in accordance with an aspect of the disclosed subject matter. As shown in flow diagram 1400 of FIG. 14, training data 1412 may include one or more of stage inputs 1414 and known outcomes 1418 related to a machine learning model to be trained. The stage inputs 1414 may be from any applicable source including a component or set shown in the figures provided herein. The known outcomes 1418 may be included for machine learning models generated based on supervised or semi-supervised training. An unsupervised machine learning model might not be trained using known outcomes 1418. Known outcomes 1418 may include known or desired outputs for future inputs similar to or in the same category as stage inputs 1414 that do not have corresponding known outputs.

The training data 1412 and a training algorithm 1420 may be provided to a training component 1430 that may apply the training data 1412 to the training algorithm 1420 to generate a trained machine learning model 1450. According to an implementation, the training component 1430 may be provided comparison results 1416 that compare a previous output of the corresponding machine learning model to apply the previous result to re-train the machine learning model. The comparison results 1416 may be used by the training component 1430 to update the corresponding machine learning model. The training algorithm 1420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1400 may be a trained machine learning model 1450.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

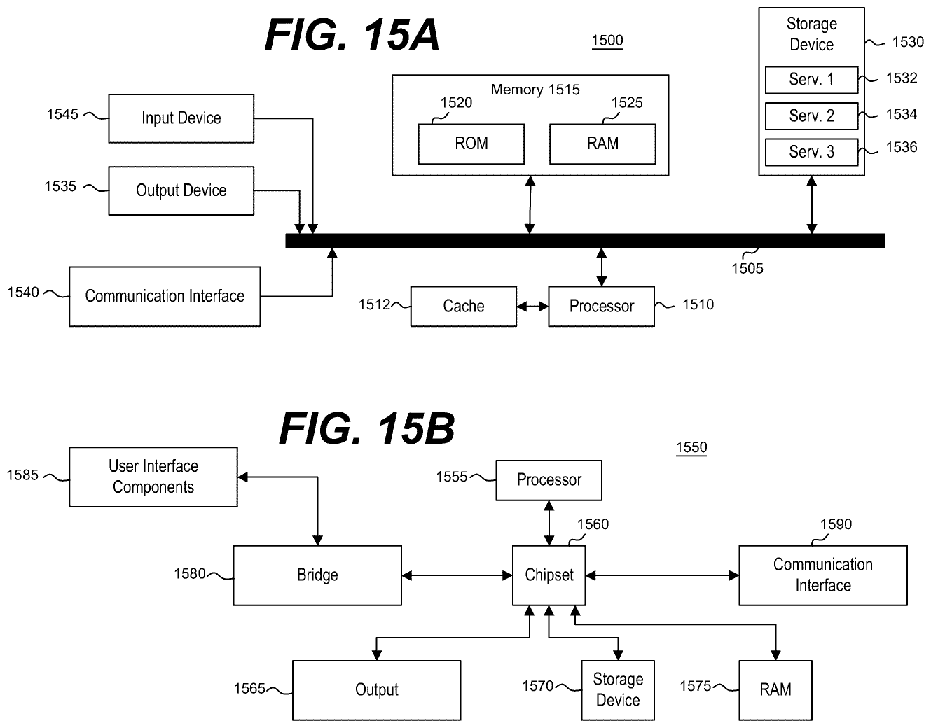

FIG. 15A illustrates an architecture of computing system 1500, according to example embodiments. System 1500 may be representative of at least a portion of organization computing system 104. One or more components of system 1500 may be in electrical communication with each other using a bus 1505. System 1500 may include a processing unit (CPU or processor) 1510 and a system bus 1505 that couples various system components including the system memory 1515, such as read only memory (ROM) 1520 and random access memory (RAM) 1525, to processor 1510. System 1500 may include a cache of high-speed memory connected directly with, in close proximity to, or integrated as part of processor 1510. System 1500 may copy data from memory 1515 and/or storage device 1530 to cache 1512 for quick access by processor 1510. In this way, cache 1512 may provide a performance boost that avoids processor 1510 delays while waiting for data. These and other modules may control or be configured to control processor 1510 to perform various actions. Other system memory 1515 may be available for use as well. Memory 1515 may include multiple different types of memory with different performance characteristics. Processor 1510 may include any general purpose processor and a hardware module or software module, such as service 1 1532, service 2 1534, and service 3 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction with the computing system 1500, an input device 1545 may represent any number of input mechanisms, such as a microphone for speech, a touch-sensitive screen for gesture or graphical input, keyboard, mouse, motion input, speech and so forth. An output device 1535 (e.g., display) may also be one or more of a number of output mechanisms known to those of skill in the art. In some instances, multimodal systems may enable a user to provide multiple types of input to communicate with computing system 1500. Communications interface 1540 may generally govern and manage the user input and system output. There is no restriction on operating on any particular hardware arrangement and therefore the basic features here may easily be substituted for improved hardware or firmware arrangements as they are developed.

Storage device 1530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1525, read only memory (ROM) 1520, and hybrids thereof.

Storage device 1530 may include services 1532, 1534, and 1536 for controlling the processor 1510. Other hardware or software modules are contemplated. Storage device 1530 may be connected to system bus 1505. In one aspect, a hardware module that performs a particular function may include the software component stored in a computer-readable medium in connection with the necessary hardware components, such as processor 1510, bus 1505, output device 1535, and so forth, to carry out the function.

FIG. 15B illustrates a computer system 1550 having a chipset architecture that may represent at least a portion of organization computing system 104. Computer system 1550 may be an example of computer hardware, software, and firmware that may be used to implement the disclosed technology. System 1550 may include a processor 1555, representative of any number of physically and/or logically distinct resources capable of executing software, firmware, and hardware configured to perform identified computations. Processor 1555 may communicate with a chipset 1560 that may control input to and output from processor 1555. In this example, chipset 1560 outputs information to output 1565, such as a display, and may read and write information to storage device 1570, which may include magnetic media, and solid-state media, for example. Chipset 1560 may also read data from and write data to RAM 1575. A bridge 1580 for interfacing with a variety of user interface components 1585 may be provided for interfacing with chipset 1560. Such user interface components 1585 may include a keyboard, a microphone, touch detection and processing circuitry, a pointing device, such as a mouse, and so on. In general, inputs to system 1550 may come from any of a variety of sources, machine generated and/or human generated.

Chipset 1560 may also interface with one or more communication interfaces 1590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1555 analyzing data stored in storage device 1570 or RAM 1575. Further, the machine may receive inputs from a user through user interface components 1585 and execute appropriate functions, such as browsing functions by interpreting these inputs using processor 1555.

It may be appreciated that example systems 1500 and 1550 may have more than one processor 1510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system for performing an action using agentic artificial intelligence (AI), the system comprising:
a tennis specific orchestrator;
a plurality of agents, wherein each agent is associated with the tennis specific orchestrator;
a superior orchestrator trained to select one or more sport specific orchestrators including the tennis specific orchestrator, wherein the tennis specific orchestrator is trained to select a one or more agents to perform an action based on one or more user inputs, wherein the superior orchestrator is configured to execute instructions for:
receiving the one or more user inputs, wherein the one or more user inputs include a description;
determining contextual information and intentional information associated with the description;
selecting the one or more sport specific orchestrators, including the tennis specific orchestrator, based on the contextual information and intentional information associated with the description, wherein each of the one or more sport specific orchestrators are trained using one or more sport specific languages, and wherein the tennis specific orchestrator is trained using a tennis specific language,
wherein the one or more sport specific orchestrators, including the tennis specific orchestrator, are configured to execute instructions for:
selecting the plurality of agents for performing the action associated with the description based on the contextual information and the intentional information,
wherein the one or more agents are configured to execute instructions for:
retrieving a plurality of information based on the contextual information and intentional information;
determining steps for performing the action associated with the description; and
activating agent processes to perform the action based on the determined steps for performing the action.

2. The system of claim 1, wherein the one or more user inputs comprise at least one of text, audio, drawing, or video.

3. The system of claim 1, wherein determining the plurality of contextual information and intentional information further comprises:
extracting one or more metadata items relating to the description; and
determining at least one keyword or tag associated with the description.

4. The system of claim 1, wherein selecting the plurality of agents further comprises:
mapping one or more metadata items to at least one or more event streams; and
determining at least one keyword or tag associated with the one or more metadata items relating to the at least one or more event streams.

5. The system of claim 4, wherein performing the action comprises generating one or more sports content based on the information received and wherein the one or more agents are configured to execute instructions for:
matching the at least one keyword or tag associated with the description to the determined at least one keyword or tag relating to the at least one or more event streams.

6. The system of claim 5, wherein generating the one or more sports content further comprises retrieving one or more content items relating to a subset of the at least one or more event streams.

7. The system of claim 1, wherein each of the plurality of agents are trained to retrieve the plurality of information relating to one or more sports tracking data and one or more sports event data, and to arrange the one or more sports tracking data and the one or more sports event data for performing the action.

8. A method for performing a tennis related action, the method comprising:
receiving one or more user inputs, wherein the one or more user inputs include at least a description;
determining a plurality of contextual and intentional information associated with the description;
determining a tennis specific language model based on the plurality of contextual and intentional information;
determining one or more tennis events and tracking data based on the plurality of contextual and intentional information; and
retrieving one or more content items relating to the one or more tennis events and tracking data using the tennis specific language model; and
transmitting the one or more content items for display on a user device.

9. The method of claim 8, wherein the tennis specific language is trained using one or more sport generic attributes and tennis specific attributes.

10. The method of claim 9, wherein the sport generic attributes includes a number of players, a type of surface, a team sport, or an individual sport.

11. The method of claim 9, wherein the tennis specific attributes includes a starting line-up, a possession based sport, a segmented sport, a time constraint, a point distribution, or a penalty based sport.

12. The method of claim 9, wherein determining a plurality of contextual and intentional information further includes:
extracting one or more metadata items relating to the description;
determining at least one keyword or tag associated with the description; and
mapping the one or more metadata items to the at least one keyword or tag.

13. The method of claim 12, wherein determining the tennis specific language models further includes:
matching the at least one keyword or tag with the sport generic attributes and the tennis specific attributes;
determining a threshold number of tennis specific attributes identified for the tennis specific language model,
wherein if the threshold number of tennis specific attributes for one of the tennis specific language model is exceeded, then selecting the tennis specific language.

14. A non-transitory computer readable medium configured to store processor-readable instructions, wherein when executed by a processor, the instructions perform operations comprising:
a superior orchestrator trained to select one or more sport specific orchestrators including a tennis specific orchestrator, wherein the tennis specific orchestrator is trained to select a plurality of agents to perform an action based on one or more user inputs, wherein the superior orchestrator is configured to execute instructions for:
receiving the one or more user inputs, wherein the one or more user inputs include a description;
determining contextual information and intentional information associated with the description;
selecting the one or more sport specific orchestrators, including the tennis specific orchestrator, based on the contextual information and intentional information associated with the description, wherein each of the one or more sport specific orchestrators are trained using one or more sport specific languages, and wherein the tennis specific orchestrator is trained using a tennis specific language,
wherein the one or more sport specific orchestrators, including the tennis specific orchestrator, are configured to execute instructions for:
selecting the plurality of agents for performing the action associated with the description based on the contextual information and the intentional information,
wherein the one or more agents are configured to execute instructions for:
retrieving a plurality of information based on the contextual information and intentional information;
determining steps for performing the action associated with the description; and
activating agent processes to perform the action based on the determined steps for performing the action.

15. The non-transitory computer readable medium of claim 14, wherein the one or more user inputs comprise at least one of text, audio, drawing, or video.

16. The non-transitory computer readable medium of claim 14, wherein determining the plurality of contextual information and intentional information further comprises:
extracting one or more metadata items relating to the description; and
determining at least one keyword or tag associated with the description.

17. The non-transitory computer readable medium of claim 14, wherein determining the plurality of agents further comprises:
mapping one or more metadata items to at least one or more event streams; and
determining at least one keyword or tag associated with the one or more metadata items relating to the at least one or more event streams.

18. The non-transitory computer readable medium of claim 17, wherein performing the action comprises generating one or more tennis content based on the information received and wherein the one or more agents are configured to execute instructions for:
matching the at least one keyword or tag associated with the description to the determined at least one keyword or tag relating to the at least one or more event streams.

19. The non-transitory computer readable medium of claim 18, wherein generating the one or more tennis content further comprises retrieving one or more content items relating to a subset of the at least one or more event streams.

20. The non-transitory computer readable medium of claim 14, wherein each of the plurality of agents are trained to retrieve the plurality of information relating to one or more tennis tracking data and one or more tennis event data, and to arrange the one or more tennis tracking data and the one or more tennis event data for performing the action.
